(19) United States
(12) Patent Application Publication
(10) Pub. No.: US 2020/0413362 A1
(43) Pub. Date: Dec. 31, 2020

(54) USER TERMINAL AND RADIO COMMUNICATION METHOD

(71) Applicant: NTT DOCOMO, INC., Tokyo (JP)

(72) Inventors: Ryosuke Osawa, Tokyo (JP); Kazuki Takeda, Tokyo (JP); Satoshi Nagata, Tokyo (JP); Yuichi Kakishima, Palo Alto, California (US)

(73) Assignee: NTT DOCOMO, INC., Tokyo (JP)

(21) Appl. No.: 16/975,753

(22) PCT Filed: Feb. 27, 2019
(86) PCT No.: PCT/JP2019/007631

§ 371 Date: Aug. 26, 2020

(30) Foreign Application Priority Data
Feb. 27, 2018 (JP) 2018-048578

(51) Int. Cl. H04W 56/00; H04W 72/04

(52) U.S. Cl. CPC H04W 56/0045; H04W 72/0493; H04W 72/046; H04W 72/0413

(57) ABSTRACT

One aspect of the present disclosure is designed to control UL transmission and the like properly by using timing advances when beamforming is employed. A user terminal, according to the aspect of the present disclosure, has a transmission section that transmits one or more UL signals based on one or more timing advances, and a control section that controls a timing advance to apply to transmission of a UL signal based on at least one of UL resource information, antenna port information and beam information for the UL signal.

### TECHNICAL FIELD

This disclosure relates to a user terminal and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower latency and so on (see non-patent literature 1). In addition, LTE-A (LTE advanced and LTE Rel. 10, 11, 12 and 13) has been standardized for the purpose of achieving increased capacity and enhancement beyond LTE (LTE Rel. 8 and 9) and so on.

Successor systems of LTE are also under study (for example, referred to as “FRA (Future Radio Access),” “5G (5th generation mobile communication system),” “5G+(plus),” “NR (New Radio),” “NX (New radio access),” “FX (Future generation radio access),” “LTE Rel. 14 or 15 and later versions,” etc.).

In existing LTE systems (for example, LTE Rel. 8 to 13), a user terminal (UE (User Equipment)) may apply precoding to transmitting signals, per transmitting antenna, based on precoding matrix indicators (PMIs) given as feedback from the network (for example, a base station (eNB (eNode B))), and transmit these signals.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

In existing LTE systems, the timing of UL transmission is controlled based on timing advance. To be more specific, every UE controls the timing of UL transmission, per timing advance group (TAG) that is configured in advance. As a result of this, the timing to receive UL signals transmitted from different UEs can be coordinated on the UL receiving end (for example, in a base station).

Now, envisaging future radio communication systems (for example, NR), studies are in progress to use beamforming (BF) for both transmission and/or receipt, primarily for the purpose of relieving the difficulty of reserving coverage when the carrier frequency increases, and reducing the propagation loss of radio waves. For example, UE may be expected to make UL transmission (for example, UL signals and/or UL channels) with one or more transmitting beams.

Nevertheless, how to control timing advance when employing beamforming has not been studied much yet. Failure to control timing advance properly when employing beamforming (for example, during UL transmission to use multiple beams) might lead to a deterioration in the quality of communication.

It is therefore an object of the present disclosure to provide a user terminal and a radio communication method, which are capable of controlling UL transmission properly by using timing advance when beamforming is employed.

### Solution to Problem

In accordance with one aspect of the present disclosure, a user terminal has a transmission section that transmits one or more UL signals based on one or more timing advances, and a control section that controls a timing advance to apply to transmission of a UL signal based on at least one of UL resource information, antenna port information and beam information for the UL signal.

### Advantageous Effects of Invention

According to one aspect of the present disclosure, it is possible to properly control, for example, UL transmission to use timing advance, when beamforming is employed.

### BRIEF DESCRIPTION OF DRAWINGS

FIG. 1 is a diagram to explain multiple-timing advance;

FIG. 2 is a diagram to show an example of communication to employ multiple beams;

FIG. 3 is a diagram to show an example of beam switching;

FIG. 4 is a diagram to show an exemplary schematic structure of a radio communication system according to the present embodiment;

FIG. 5 is a diagram to show an exemplary overall structure of a radio base station according to the present embodiment;

FIG. 6 is a diagram to show an exemplary functional structure of a radio base station according to the present embodiment;

FIG. 7 is a diagram to show an exemplary overall structure of a user terminal according to the present embodiment;

FIG. 8 is a diagram to show an exemplary functional structure of a user terminal according to the present embodiment; and

FIG. 9 is a diagram to show an exemplary hardware structure of a radio base station and a user terminal according to the present embodiment.

### DESCRIPTION OF EMBODIMENTS

Envisaging future radio communication systems (for example, NR), studies are in progress to use beamforming (BF) for both transmission and receipt, primarily for the purpose of relieving the difficulty of reserving coverage when the carrier frequency increases, and reducing the propagation loss of radio waves.

BF refers to the technique of forming beams (antenna directivities) by, for example, using a very large number of antenna elements, and controlling the amplitude and/or the phase of signals transmitted/received in each element (this is also referred to as “precoding”). Note that such MIMO (Multiple Input Multiple Output) to use a very large number of antenna elements is also referred to as “massive MIMO.”

BF can be classified into digital BF and analog BF. Digital BF refers to a method for performing precoding signal processing on baseband (digital signal), and a number of beams to match the number of antenna ports (or RF chains) can be formed at any given timing.

Analog BF refers to a method to use a phase shifter on RF (Radio Frequency). In this case, since it is only necessary to rotate the phase of RF signals, analog BF can be realized with simple and inexpensive configurations, but it is still not possible to form a number of beams at the same timing.

Note that it is also possible to implement a hybrid BF configuration that combines digital BF and analog BF. Forming a large number of beams by using digital BF alone is likely to lead to expensive circuit structures, so that a hybrid BF configuration may be suitable especially for massive MIMO.

Envisaging NR, studies are underway to allow both a base station (which may be referred to as a “BS,” “transmission/reception point (TRP),” an “eNB (eNode B),” a “gNB,” etc.) and UE to form transmitting/receiving beams and achieve gain.

Reciprocity-based transmission and non-reciprocity-based transmission are under study as methods of selecting beams. In the former case, the transmitting end selects transmitting beams (and/or transmitting beam candidates) based on signal measurement results transmitted from the receiving end. For example, if the transmitting end is UE and the receiving end is a gNB, in reciprocity-based transmission, the UE may select a transmitting beam based on a signal (for example, a reference signal) that is transmitted from the gNB.

Note that “measurement” as used in the present specification may refer to the measurement of at least one of RSRP (Reference Signal Received Power), RSRQ (Reference Signal Received Quality), RSSI (Received Signal Strength Indicator), SINR (Signal to Interference plus Noise Ratio), SNR (Signal to Noise Ratio), path loss, interference power and so forth, or refer to measurements for determining other power and/or quality-related indicators.

Also, the signals to use in the above measurement may include, for example, cell-specific reference signals (CRSs), channel state information-reference signals (CSI-RSs), measurement reference signals (such as sounding reference signals (SRSs)) and so forth, or reference signals that are defined apart from these (for example, beam-specific reference signals (BRSs), which are beam-specific (which vary per beam)) may be used.

In the event of non-reciprocity-based transmission, the receiving end transmits a signal (information) that specifies a beam for the transmitting end, and the transmitting end uses the specified beam. For example, the codebook transmission (codebook-based transmission) used in existing LTE (Rel. 8 to 13) and the like corresponds to non-reciprocity-based transmission.

The mode in which UE selects beams autonomously, as mentioned earlier in connection with reciprocity-based transmission, may be referred to as “UE centricity,” “UE-centric mode,” “UE-initiated control,” and so on. In UE-centric operation, the UE may select transmitting beams and/or receiving beams for use, in a self-directed way.

In UE-centric operation, the gNB may operate so as to assist the UE's selection of beams. It then follows that UE-centric operation may be referred to as “gNB-assisted mode,” “gNB-aided mode,” and so on.

In addition, as mentioned earlier in connection with non-reciprocity-based transmission, the mode in which beams are selected autonomously by the gNB and reported to the UE may be referred to as “gNB centricity,” “gNB centric mode,” “gNB-initiated control,” “BS centricity” and so forth.

In gNB-centric operation, information related to transmitting beams and/or receiving beams (for example, information that indicates (specifies) beams) may be reported from the gNB to the UE. The information related to transmitting/receiving beams may be reported by using higher layer signaling (for example, RRC (Radio Resource Control) signaling, MAC (Medium Access Control) signaling (for example, MAC control element (CE)), broadcast information, etc.), physical layer signaling (for example, downlink control information (DCI), uplink control information (UCI), etc.) and so on, or a combination of these.

Note that, in this specification, beams are distinguished (differences between multiple beams are judged) based on, but not limited to, at least one of following (1) to (8):

(1) resources (for example, the time and/or frequency resources, the number of resources, etc.);

(2) antenna ports (for example, the port index of the DMRS (DeModulation Reference Signal) and/or the measurement reference signal (SRS (Sounding Reference Signal)), the number of ports, resources corresponding to the ports, etc.);

(3) precoding (for example, whether or not precoding is applied, precoding weight, etc.);

(4) transmission power;

(5) phase rotation;

(6) beam widths;

(7) beam angles (for example, tilt angle); and

(8) the number of layers.

Also, the term “beam” as used herein may be used interchangeably with at least one of (1) to (8) listed above, and, for example, a “beam” may be interpreted as meaning a “resource,” an “antenna port,” a “DMRS port,” an “SRS port,” a “reference signal antenna port” and so on. Also, a “beam” may be interpreted as meaning a “transmitting beam and/or a receiving beam.”

Now, in existing LTE systems, uplink carrier aggregation (UL-CA) to use multiple-timing advance (MTA) is supported. UE controls the timing of UL transmission, per timing advance group (TAG) that is configured in advance.

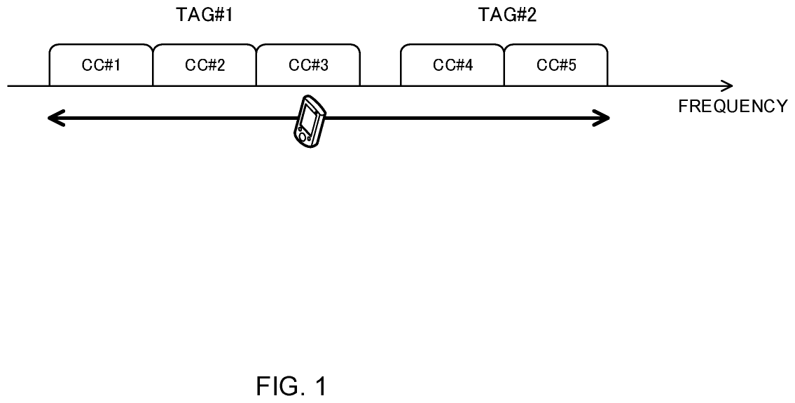

To be more specific, multiple-timing advance (MTA), which enables individual and different timing control between component carriers performing inter-band carrier aggregation, has been introduced in LTE Rel. 11 (see FIG. 1). This makes it possible to optimize carrier aggregation by non-co-located component carriers.

CA to employ multiple-timing advance supports timing advance groups (TAGs) that are classified based on transmission timings. Referring to FIG. 1, CC #1 to CC #3 are grouped into TAG #1, and CC #4 and CC #5 are grouped into TAG #2. The timing of transmission is controlled based on timing advance values, per TAG, individually.

In this way, in CA in which multiple-timing advance is employed, a user terminal individually adjusts the transmission timings for component carriers (or cells) belonging to each TAG, so that the timings at which uplink signals from the user terminal are received at the radio base station can be coordinated. For example, the timing at which the user terminal transmits uplink transmission signals can be controlled individually between CC #1 to CC #3, which are formed by the radio base station, and CC #4 and CC #5, which are formed by an RRH (remote radio head) connected to that radio base station.

For example, when multiple-timing advance is employed, information about the TAG where each CC belongs can be reported from the base station to the UE. The UE controls the timing of UL transmission for each CC based on TAGs configured in advance.

As described above, future radio communication systems are under study to perform UL transmission by using one or more beams. Nevertheless, how to control timing advance when employing beamforming like this has not been studied much yet. Failure to control timing advance (for example, multiple-timing advance) properly when employing beamforming might lead to a deterioration in the quality of communication.

The present inventors have focused on the fact that, When UL transmission (for example, transmission of UL signals and/or UL channels) is performed using one or more beams, timing advance is controlled by taking into account the conditions of beams (or UL resources, antenna ports, etc.) to apply to this UL transmission. So, the present inventors have come up with the idea of controlling the timing advance (for example, multiple-timing advance) to apply to UL transmission, on the UE end.

Now, embodiments of this disclosure will be described in detail below with reference to the accompanying drawings. The radio communication methods according to the herein-contained embodiments (examples) may be applied alone, or may be applied in combination.

### First Example

With a first example of the present invention, timing advance (multiple-timing advance) is controlled on the UE end, based on beam information.

The beam information may be at least one of a beam index (BI), a rank indicator (RI), a precoding matrix indicator (PMI), a transmitted RI (TRI), a transmitted PMI (TPMI), a given reference signal's port index (for example, a DMRS port index (DPI), an SRS port index (SPI), etc.), a given reference signal's resource indicator (for example, a CSI-RS resource indicator (CRI), a DMRS resource index (DRI), an SRS resource index (SRI), etc.), quasi-co-location (QCL) information, beam pair link (BPL) information, and so forth.

The beam information may be classified into UL beam information, which is applied to UL transmission, and DL beam information, which is applied to DL transmission. Furthermore, the beam information may be reported from the base station to the UE, or may be determined by the UE, implicitly, based on given information. The beam information may be reported from the base station to the UE by using higher layer signaling (for example, RRC signaling, MAC signaling, broadcast information (MIB and SIB), etc.), physical layer signaling (for example, DCI) or a combination of these.

Note that QCL means that the pseudo geographical relationship is identical (or can be regarded as being identical). For example, considering the geographical locations of individual transmission points (channel characteristics of downlink signals transmitted from individual transmission points), if different antenna ports share the same long-term channel characteristics, these antenna ports may be assumed to be quasi-co-located (QCL).

QCL information may allow assuming that a given signal, channel or antenna port is quasi-co-located (QCL) with another signal, channel, or antenna port. The UE may assume that the same beam is applied to multiple signals (channel/antenna ports), based on QCL information.

BPL information is information to relate to transmitting/receiving beam pairs (pairs of transmitting beams used on the transmitting end (for example, UE) and receiving beams used on the receiving end (for example, gNB)), and may show, for example, beam pair indices (BPIs) associated with BPLs. The UE may specify gNB beams corresponding to UE beams, based on BPL information that is reported.

For example, the UE may control (or adjust) the timing advance to apply to UL transmission based on UL beam information. For example, the UE may determine the timing advance based on UL beam information. Alternatively, the UE may change the timing advance (base timing advance) reported in advance from the base station, based on UL beam information. For example, the UE may adjust the timing advance by applying a given offset to the base timing advance based on UL beam information.

The UE may control (or adjust) the timing advance to apply to UL transmission based on DL beam information associated with UL beams. The DL beam information associated with each UL beam may be reported from the base station to the UE. Alternatively, the DL beam information associated with UL beams may be determined on the UE end (for example, reciprocity-based transmission and the like).

For example, the UE may determine the timing advance based on UL beam information. Alternatively, the UE may change the timing advance (base timing advance) reported in advance from the base station, based on DL beam information. For example, the UE may adjust the timing advance by applying a given offset to the base timing advance based on DL beam information.

Since the beam information (beam conditions) to apply to UL transmission is controlled based on the communication status of UL communication and/or the like, it is possible to properly receive a number of UL signals on the receiving end, by controlling the timing advance based on the beam information. As a result, when beamforming is employed (for example, during UL transmission to use multiple beams), the timing advance can be controlled properly, so that the deterioration in the quality of communication and the like can be prevented.

The UE may control the timing advance to apply to UL transmission based on QCL information. For example, the UE may control the timing advance in QCL information units. In this case, the timing advance may be determined based on QCL information. Alternatively, the UE may change the timing advance (base timing advance) reported in advance from the base station, based on QCL information. For example, the UE may adjust the timing advance by applying a given offset to the base timing advance based on QCL information.

By adjusting the timing advance by taking into account the QCL information, the timing advance can be adjusted properly.

<Transmission of Multiple UL Beams>

When the UE performs UL transmission using multiple beams (or UL resources, antenna ports, etc.), one (or the same) timing advance may be applied to these beams. That is, the UE applies a given timing advance that is determined based on beam information and/or the like, to multiple UL beams, in common.

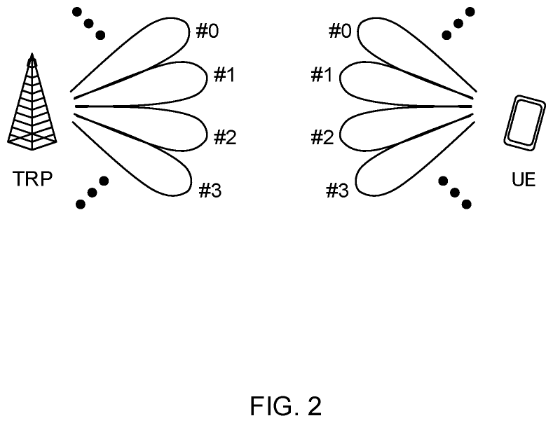

FIG. 2 shows an example in which the UE performs UL transmission using a number of UL beams (here, UL beams #0 to #3). The UE may apply the same given timing advance (a given timing advance value) to these UL beams #0 to #3.

The given timing advance to apply to the multiple beams may be the average of a number of timing advance values. Alternatively, the given timing advance may be the maximum value or the minimum value of a number of timing advance values.

For example, the UE may obtain a number of timing advances (timing advance values) based on beam information that corresponds to each of UL beams #0 to #3, and apply the average value of these timing advances to the UL transmission of UL beams #0 to #3. The beam information corresponding to each of UL beams #0 to #3 may be at least one of information about UL beams #0 to #3, DL beam information corresponding to UL beams #0 to #3, respectively, and QCL information of each UL beam.

Alternatively, the UE may obtain a number of timing advances based on beam information that corresponds to each of UL beams #0 to #3, and apply the maximum value or the minimum value of these timing advances to the UL transmission of UL beams #0 to #3.

As described above, when UL transmission is performed using a number of UL beams, it is possible to prevent the processing load at the UE end from increasing, by applying a common timing advance. In particular, when each UL beam shows little difference in quality, it is preferable to apply a common timing advance.

When the UE performs UL transmission using multiple beams (or UL resources, antenna ports, etc.), individual timing advances may be applied to these beams, respectively. That is, the UE applies timing advances that are determined based on beam information and/or the like, to a number of UL beams, respectively.

For example, referring to FIG. 2, the UE may apply different timing advances (timing advance values) to a number of UL beams #0 to #3, separately. The timing advance to apply to each UL beam may be determined, individually, based on beam information that corresponds to each of UL beams #0 to #3.

In this way, when UL transmission is performed using a number of UL beams, individual timing advances are applied to these UL beams, respectively, so that it is possible to configure each UL beam's transmission timing in a flexible manner. In particular, when each UL beam's quality varies significantly, it is preferable to configure timing advances on a per beam basis.

Furthermore, the timing advance control units may be grouped. For example, referring to FIG. 2, assuming that UL beams #0 and #1 are the first group and UL beams #2 and #3 are the second group, a common timing advance may be applied to the first group, and a common timing advance may be applied to the second group. The timing advance to apply to each group may be determined based on beam information that corresponds to the UL beams included in each group, by using any of the methods described above.

Information regarding the UL beam groups may be reported from the base station to the UE. Alternatively, the UE may identify the groups of UL beams based on given conditions (for example, UL beam information). For example, the UE may determine that UL beams, between which the difference of a given parameter value in UL beam information is less than or equal to a given value, belong to the same group.

### Second Example

With a second example of the present invention, how to control timing advance when switching UL beams will be described.

UE may exert control so that, when the quality of a UL beam deteriorates, UL transmission is performed by changing (or switching) the UL beam to another UL beam. When changing a UL beam, it is necessary to properly control the timing advance to apply to the UL beam after the change. Assuming that a UL beam is changed, an example of how to control the timing advance to apply to the UL beam after the change will be described below.

### Control Example 1

In control example 1, the same timing advance is applied (maintained) before and after a UL beam is changed (switched). That is, when a beam is switched, the UE applies the same timing advance to the UL beam after the change.

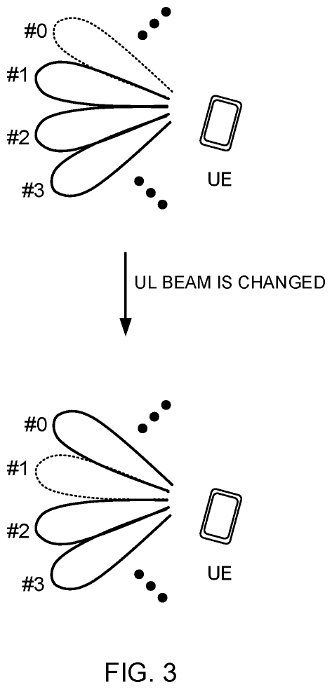

FIG. 3 shows a case in which the UE switches the UL beams to use in UL transmission. Here, a case in which UL beams #1 to #3 are changed to UL beams #0, #2, and #3 is shown (that is, a case in which the UE quits using UL beam #1 and uses UL beam #0 newly). Note that, the example of changing beams illustrated in FIG. 3 is by no means limiting.

Assume the case in which a common given timing advance is applied to UL beams #1 to #3 before UL beams are changed. In this case, even after UL beams changed, the same given timing advance as before the change is applied to each of UL beams #0, #2, and #3. By this means, there is no need to change the timing advance before and after UL beams are changed, so that the processing load on the UE can be reduced.

Assume the case in which, before UL beams are changed, individual timing advances are configured for UL beams #1 to #3, respectively. In this case, even after UL beams are changed, the timing advance applied to UL beam #1 is applied to UL beam #0.

In this way, the timing advances to apply are maintained before and after UL beams are changed, so that it is possible to prevent the processing load on the UE end from increasing.

### Control Example 2

In control example 2, a timing advance is reset when a UL beam is changed (switched). That is, UE configures a new timing advance when a beam is switched.

Assume the case in which a common given timing advance is applied to UL beams #1 to #3 before UL beams are changed. When UL beams are changed (switched), the UE resets the given timing advance, and configures a new timing advance. The timing advance to configure newly may be determined by any of the methods described with the above-described first example, based on beam information that corresponds to UL beams #0, #2, and #3 used after the change.

In this way, separate timing advances are configured before and after a beam is changed (switched), so that the timing advance to apply can be controlled by taking into account the UL beams that are actually used. As a result of this, even when a UL beam is switched to a UL beam of significantly different conditions, an appropriate timing advance can be configured after the switch.

Assume the case in which, before UL beams are changed, individual timing advances are configured for UL beams #1 to #3, respectively. When UL beams are changed (switched), the UE at least resets the timing advance corresponding to UL beam #1, and configures a new timing advance to apply to UL beam #0.

For UE beams #2 and #3, even after the switch of the UL beam (switch from UL beam #1 to #0), the timing advance that is configured before the switch may be applied. Alternatively, the timing advances for UL beams #2 and #3 may also be reset and configured anew.

In this way, separate timing advances are configured before and after a beam is changed (switched), so that the timing advance to apply can be controlled by taking into account the UL beams that are actually used. In addition, when a UL beam is not switched, the same timing advance is applied, so that the processing load on the UE can be prevented from increasing.

(Radio Communication System)

Now, the structure of a radio communication system according to the present embodiment will be described below. In this radio communication system, communication is performed using at least one of the above examples or a combination of these.

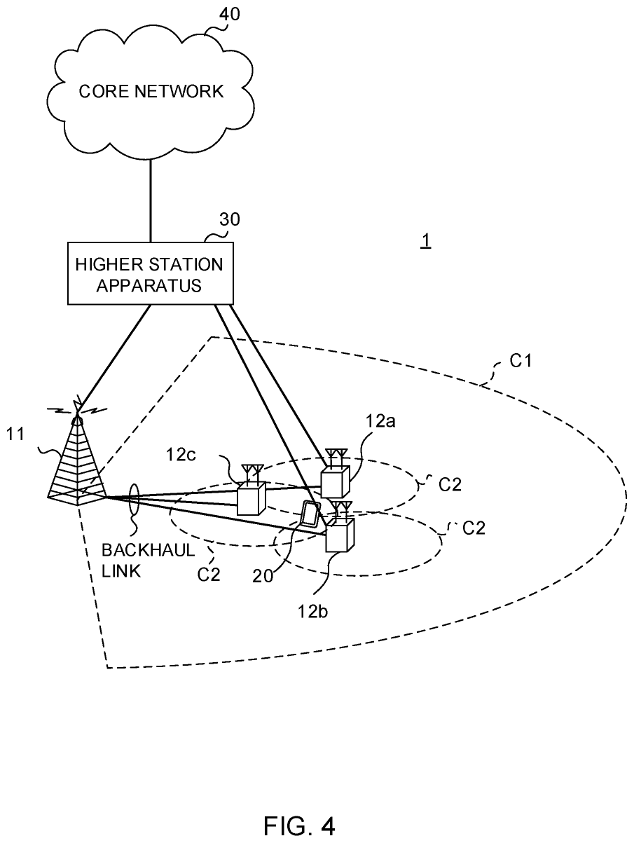

FIG. 4 is a diagram to show an exemplary schematic structure of a radio communication system according to the present embodiment. A radio communication system 1 can adopt carrier aggregation (CA) and/or dual connectivity (DC) to group a number of fundamental frequency blocks (component carriers) into one, where the LTE system bandwidth (for example, 20 MHz) constitutes one unit.

Note that the radio communication system 1 may be referred to as “LTE (Long-term evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be seen as a system to implement these.

The radio communication system 1 includes a radio base station 11 that forms a macro cell C1, with a relatively wide coverage, and radio base stations 12 (12a to 12c) that are placed within the macro cell C1 and that form small cells C2, which are narrower than the macro cell C1. Also, user terminals 20 are placed in the macro cell C1 and in each small cell C2. The arrangement and number of cells and user terminals 20 and so forth are not limited to those illustrated in the drawings.

The user terminals 20 can connect with both the radio base station 11 and the radio base stations 12. The user terminals 20 might use the macro cell C1 and the small cells C2 at the same time by means of CA or DC. Furthermore, the user terminals 20 may apply CA or DC using a number of cells (CCs) (for example, five or fewer CCs or six or more CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

Furthermore, the user terminals 20 can communicate by using time division duplexing (TDD) and/or frequency division duplexing (FDD), in each cell. Furthermore, in each cell (carrier), a single numerology may be used, or a number of different numerologies may be used.

A numerology may refer to a communication parameter that is applied to transmission and/or receipt of a given signal and/or channel, and represent at least one of the subcarrier spacing, the bandwidth, the duration of symbols, the length of cyclic prefixes, the duration of subframes, the length of TTIs, the number of symbols per TTI, the radio frame configuration, the filtering process, the windowing process, and so on.

The radio base station 11 and a radio base station 12 (or two radio base stations 12) may be connected with each other by cables (for example, by optical fiber, which is in compliance with the CPRI (Common Public Radio Interface), the X2 interface and so on), or by radio.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but these are by no means limiting. Also, each radio base station 12 may be connected with the higher station apparatus 30 via the radio base station 11.

Note that the radio base station 11 is a radio base station having a relatively wide coverage, and may be referred to as a “macro base station,” a “aggregate node,” an “eNB (eNodeB),” a “transmitting/receiving point” and so on. Also, the radio base stations 12 are radio base stations each having a local coverage, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” unless specified otherwise.

The user terminals 20 are terminals that support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a number of narrow frequency bandwidths (subcarriers) and mapping data to each subcarrier. SC-FDMA is a single-carrier communication scheme to mitigate interference between terminals by dividing the system bandwidth into bands that are each formed with one or contiguous resource blocks, per terminal, and allowing a number of terminals to use mutually different bands. Note that the uplink and downlink radio access schemes are not limited to the combinations of these, and other radio access schemes may be used as well.

In the radio communication system 1, a downlink shared channel (PDSCH (Physical Downlink Shared CHannel)), which is used by each user terminal 20 on a shared basis, a broadcast channel (PBCH (Physical Broadcast CHannel)), downlink L1/L2 control channels and so on are used as downlink channels. User data, higher layer control information, SIBs (System Information Blocks) and so on are communicated in the PDSCH. Also, the MIB (Master Information Blocks) is communicated in the PBCH.

The downlink L1/L2 control channels include at least one of downlink control channels (such as a PDCCH (Physical Downlink Control CHannel) and/or an EPDCCH (Enhanced Physical Downlink Control CHannel)), a PCFICH (Physical Control Format Indicator CHannel), and a PHICH (Physical Hybrid-ARQ Indicator CHannel). Downlink control information (DCI), which includes PDSCH and/or PUSCH scheduling information and so on, is communicated by the PDCCH.

Note that scheduling information may be reported in DCI. For example, the DCI to schedule receipt of DL data may be referred to as “DL assignment,” and the DCI to schedule transmission of UL data may also be referred to as “UL grant.”

The number of OFDM symbols to use for the PDCCH is communicated by the PCFICH. HARQ (Hybrid Automatic Repeat reQuest) delivery acknowledgment information (also referred to as, for example, “retransmission control information,” “HARQ-ACKs,” “ACK/NACKs,” etc.) in response to the PUSCH is transmitted by the PHICH. The EPDCCH is frequency-division-multiplexed with the PDSCH (downlink shared data channel) and used to communicate DCI and so on, like the PDCCH.

In the radio communication system 1, an uplink shared channel (PUSCH (Physical Uplink Shared CHannel)), which is used by each user terminal 20 on a shared basis, an uplink control channel (PUCCH (Physical Uplink Control CHannel)), a random access channel (PRACH (Physical Random Access CHannel)) and so on are used as uplink channels. User data, higher layer control information and so on are communicated by the PUSCH. Also, in the PUCCH, downlink radio quality information (CQI (Channel Quality Indicator)), delivery acknowledgment information, scheduling requests (SRs) and so on are communicated. By means of the PRACH, random access preambles for establishing connections with cells are communicated.

In the radio communication system 1, cell-specific reference signals (CRSs), channel state information reference signals (CSI-RSs), demodulation reference signals (DMRSs), positioning reference signals (PRSs) and so on are communicated as downlink reference signals. Also, in the radio communication system 1, measurement reference signals (SRSs (Sounding Reference Signals)), demodulation reference signals (DMRSs) and so on are communicated as uplink reference signals. Note that the DMRSs may be referred to as “user terminal-specific reference signals (UE-specific reference signals).” Also, the reference signals to be communicated are by no means limited to these.

<Radio Base Station>

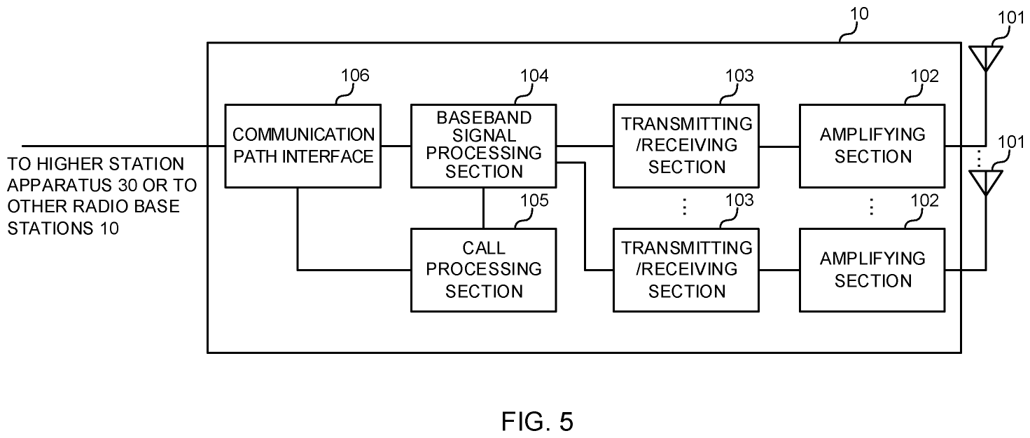

FIG. 5 is a diagram to show an exemplary overall structure of a radio base station according to the present embodiment. A radio base station 10 has a number of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30, to the baseband signal processing section 104, via the communication path interface 106.

In the baseband signal processing section 104, the user data is subjected to transmission processes, including a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present disclosure pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base station 10, and manages the radio resources.

The communication path interface section 106 transmits and receives signals to and from the higher station apparatus 30 via a given interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

Note that the transmitting/receiving sections 103 may furthermore have an analog beamforming section where analog beamforming takes place. The analog beamforming section may be constituted by an analog beamforming circuit (for example, a phase shifter, a phase shifting circuit, etc.) or analog beamforming apparatus (for example, a phase shifting device) that can be described based on general understanding of the technical field to which this disclosure pertains. Furthermore, the transmitting/receiving antennas 101 may be constituted by, for example, array antennas. In addition, the transmitting/receiving sections 103 are designed so that single-BF or multiple-BF operations can be used.

The transmitting/receiving sections 103 may transmit signals by using transmitting beams, or receive signals by using receiving beams. The transmitting/receiving sections 103 may transmit and/or receive signals by using given beams determined by the control section 301. The transmitting/receiving sections 103 may receive UL signals to which one or more timing advances are applied.

The transmitting/receiving sections 103 may receive various pieces of information described in each of the examples above, from the user terminal 20, or transmit these to the user terminal 20.

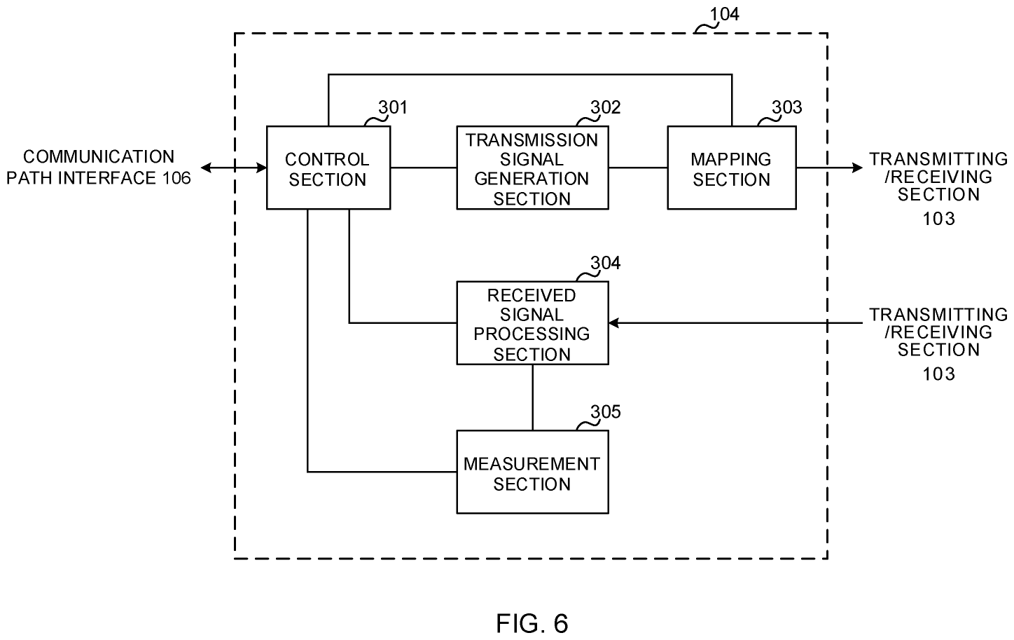

FIG. 6 is a diagram to show an exemplary functional structure of a radio base station according to the present embodiment. Note that, although this example primarily shows functional blocks that pertain to characteristic parts of the present embodiment, the radio base station 10 might have other functional blocks that are necessary for radio communication as well.

The baseband signal processing section 104 at least has a control section (scheduler) 301, a transmission signal generation section 302, a mapping section 303, a received signal processing section 304 and a measurement section 305. Note that these configurations have only to be included in the radio base station 10, and part or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present disclosure pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals (for example, signals transmitted in the PDSCH) and downlink control signals (for example, signals transmitted in the PDCCH and/or the EPDCCH, such as delivery acknowledgment information). Also, the control section 301 controls the generation of downlink control signals, downlink data signals, and so on based on the results of deciding whether or not retransmission control is necessary for uplink data signals, and so on.

The control section 301 controls scheduling of synchronization signals (for example, PSS/SSS), downlink reference signals (for example, CRS, CSI-RS, DMRS, etc.) and the like.

The control section 301 may exert control so that transmitting beams and/or receiving beams are formed by using digital BF (for example, precoding) in the baseband signal processing section 104 and/or analog BF (for example, phase rotation) in the transmitting/receiving sections 103.

The control section 301 may control the configurations of RLF and/or BR based on configuration information related to radio link failures (RLF) and/or beam recovery (BR).

The control section 301 may control radio link monitoring (RLM) and/or beam recovery (BR) for the user terminal 20. The control section 301 may exert control so that a response signal is transmitted to the user terminal 20 in response to a beam recovery request.

The transmission signal generation section 302 generates downlink signals (downlink control signals, downlink data signals, downlink reference signals, and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present disclosure pertains.

For example, the transmission signal generation section 302 generates DL assignments, which report downlink data allocation information, and/or UL grants, which report uplink data allocation information, based on commands from the control section 301. DL assignments and UL grants are both DCI, in compliance with DCI format. Also, the downlink data signals are subjected to the coding process, the modulation process and so on, by using coding rates, modulation schemes and the like that are determined based on, for example, channel state information (CSI) from each user terminal 20.

The mapping section 303 maps the downlink signals generated in the transmission signal generation section 302 to given radio resources based on commands from the control section 301, and outputs these to the transmitting/receiving sections 103. The mapping section 303 can be constituted by a mapper, a mapping circuit or mapping apparatus that can be described based on general understanding of the technical field to which the present disclosure pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminal 20 (uplink control signals, uplink data signals, uplink reference signals, etc.). The received signal processing section 304 can be constituted by a signal processor, a signal processing circuit or signal processing apparatus that can be described based on general understanding of the technical field to which the present disclosure pertains.

The received signal processing section 304 outputs the decoded information acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present disclosure pertains.

For example, the measurement section 305 may perform RRM (Radio Resource Management) measurements, CSI (Channel State Information) measurements, and so on, based on the received signals. The measurement section 305 may measure the received power (for example, RSRP (Reference Signal Received Power)), the received quality (for example, RSRQ (Reference Signal Received Quality), SINR (Signal to Interference plus Noise Ratio), SNR (Signal to Noise Ratio), etc.), the signal strength (for example, RSSI (Received Signal Strength Indicator)), transmission path information (for example, CSI) and so on. The measurement results may be output to the control section 301.

<User Terminal>

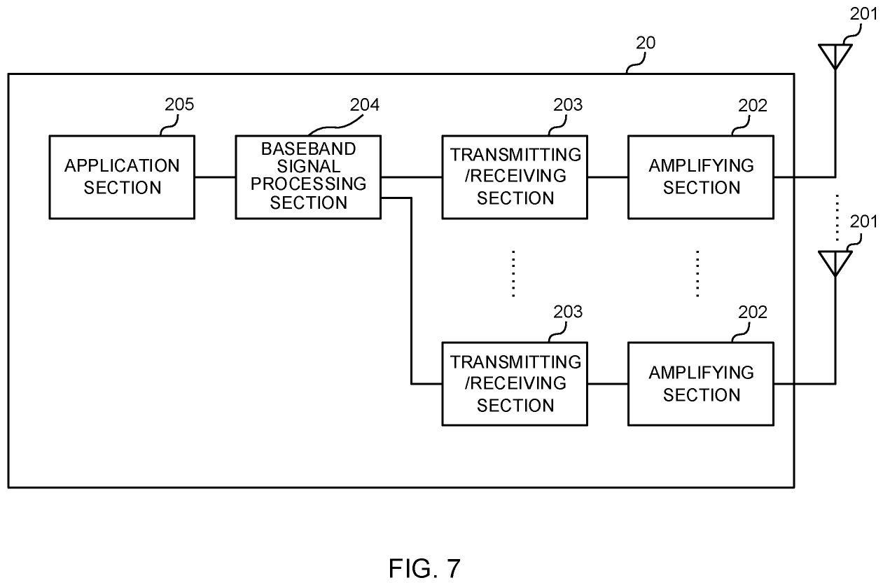

FIG. 7 is a diagram to show an exemplary overall structure of a user terminal according to the present embodiment. A user terminal 20 has a number of transmitting/receiving antennas 201, amplifying sections 202, transmitting/receiving sections 203, a baseband signal processing section 204, and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present disclosure pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process, and so on. Downlink user data is forwarded to the application section 205. The application section 205 performs processes related to higher layers above the physical layer and the MAC layer, and so on. Also, in the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203.

Baseband signals that are output from the baseband signal processing section 204 are converted into a radio frequency band in the transmitting/receiving sections 203, and transmitted. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 may further have an analog beamforming section where analog beamforming takes place. The analog beamforming section may be constituted by an analog beamforming circuit (for example, a phase shifter, a phase shifting circuit, etc.) or analog beamforming apparatus (for example, a phase shifting device) that can be described based on general understanding of the technical field to which this disclosure pertains. Furthermore, the transmitting/receiving antennas 201 may be constituted by, for example, array antennas. In addition, the transmitting/receiving sections 203 are structured so that single-BF and multiple-BF can be used.

The transmitting/receiving sections 203 may transmit signals by using transmitting beams, or receive signals by using receiving beams. The transmitting/receiving sections 203 may transmit and/or receive signals by using given beams selected by the control section 401. The transmitting/receiving sections 203 may transmit one or more UL signals based on one or more timing advances.

The transmitting/receiving sections 203 may receive various pieces of information described in each of the examples above, from the radio base station 10, and/or transmit these to the radio base station 10. For example, the transmitting/receiving sections 203 may transmit a beam recovery request to the radio base station 10.

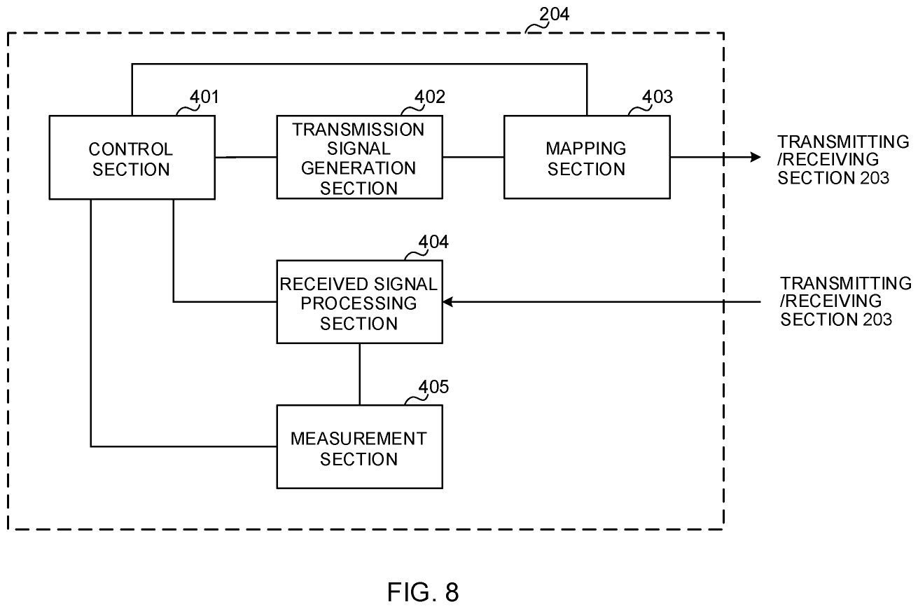

FIG. 8 is a diagram to show an exemplary functional structure of a user terminal according to the present embodiment. Note that, although this example primarily shows functional blocks that pertain to characteristic parts of present embodiment, the user terminal 20 might have other functional blocks that are necessary for radio communication as well.

The baseband signal processing section 204 provided in the user terminal 20 at least has a control section 401, a transmission signal generation section 402, a mapping section 403, a received signal processing section 404, and a measurement section 405. Note that these configurations have only to be included in the user terminal 20, and part or all of these configurations may not be included in the baseband signal processing section 204.

The control section 401 controls the whole of the user terminal 20. The control section 401 can be constituted by a controller, a control circuit or control apparatus that can be described based on general understanding of the technical field to which the present disclosure pertains.

The control section 401 controls, for example, generation of signals in the transmission signal generation section 402, allocation of signals in the mapping section 403, and so on. Furthermore, the control section 401 controls signal receiving processes in the received signal processing section 404, measurements of signals in the measurement section 405, and so on.

The control section 401 acquires the downlink control signals and downlink data signals transmitted from the radio base station 10, via the received signal processing section 404. The control section 401 controls the generation of uplink control signals and/or uplink data signals based on results of deciding whether or not retransmission control is necessary for the downlink control signals and/or downlink data signals, and so on.

The control section 401 may exert control so that transmitting beams and/or receiving beams are formed by using digital BF (for example, precoding) in the baseband signal processing section 204 and/or by using analog BF (for example, phase rotation) in the transmitting/receiving sections 203.

The control section 401 may control radio link monitoring (RLM) and/or beam recovery (BR) based on measurement results in the measurement section 405.

The control section 401 controls the timing advance to apply to the transmission of a UL signal based on at least one of UL resource information, antenna port information, and beam information for the UL signal. Furthermore, the control section 401 may control the timing advance to apply to the transmission of a UL signal based on at least one of DL resource information, antenna port information and beam information of a DL signal, related to at least one of the UL signal's UL resource information, antenna port information and beam information.

The control section 401 may control the timing advance to apply to the transmission of a UL signal in units of information related to quasi-co-location.

If the transmission section 401 transmits UL signals using at least one of a number of UL resources, a number of antenna ports and a number of beams, the control section 401 may apply the same given timing advance to these UL resources, antenna ports and beams. The control section 401 may determine the given timing advance based on a number of timing advances.

When the transmission section transmits UL signals using at least one of a number of UL resources, a number of antenna ports and a number of beams, the control section 401 may apply individual timing advances to at least one of the UL resources, antenna ports and beams, respectively.

When the control section 401 changes at least one of the UL resource information, antenna ports and beams to use for transmitting a UL signal, the control section 401 may apply the same timing advance as before the change, to at least one of the UL resource information, antenna ports and beams after the change. Alternatively, the control section 401 may reset the timing advance when changing at least one of the UL resource information, antenna ports and beams to use for transmitting a UL signal.

In addition, the control section 401 may group timing advance control units.

In addition, when various pieces of information reported from the radio base station 10 are acquired from the received signal processing section 404, the control section 401 may update the parameters used for control based on the information.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit, or signal generation apparatus that can be described based on general understanding of the technical field to which the present disclosure pertains.

For example, the transmission signal generation section 402 generates uplink control signals such as delivery acknowledgement information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and outputs these to the transmitting/receiving sections 203. The mapping section 403 can be constituted by a mapper, a mapping circuit or mapping apparatus that can be described based on general understanding of the technical field to which the present disclosure pertains.

The received signal processing section 404 performs receiving processes (for example, demapping, demodulation, decoding and so on) for received signals that are input from the transmitting/receiving sections 203. Here, the received signals include, for example, downlink signals (downlink control signals, downlink data signals, downlink reference signals, and so on) that are transmitted from the radio base station 10. The received signal processing section 404 can be constituted by a signal processor, a signal processing circuit or signal processing apparatus that can be described based on general understanding of the technical field to which the present disclosure pertains. Also, the received signal processing section 404 can constitute the receiving section according to the present disclosure.

The received signal processing section 404 outputs the decoded information acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present disclosure pertains.

For example, the measurement section 405 may perform RRM measurements, CSI measurements, and so on, based on the received signals. The measurement section 405 may measure the received power (for example, RSRP), the received quality (for example, RSRQ, SINR, SNR, etc.), the signal strength (for example, RSSI), transmission path information (for example, CSI), and so on. The measurement results may be output to the control section 401.

<Hardware Structure>

Note that the block diagrams that have been used to describe the present embodiment show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically-separate pieces of apparatus (by using cables and/or radio, for example) and using these multiple pieces of apparatus.

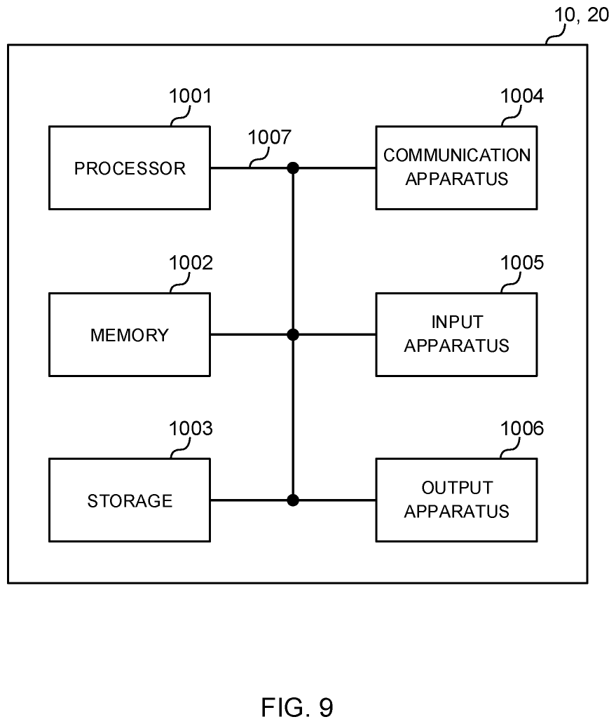

For example, the radio base station, user terminals, and so on according to the present embodiment may function as a computer that executes the processes of each example of the present embodiment. FIG. 9 is a diagram to show an exemplary hardware structure of a radio base station and a user terminal according to the present embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006, a bus 1007 and so on.

Note that, in the following description, the term “apparatus” may be replaced by “circuit,” “device,” “unit” and so on. The hardware structure of a radio base station 10 and a user terminal 20 may be designed to include one or more of each apparatus shown in the drawings, or may be designed not to include part of the apparatus.

For example, although only one processor 1001 is shown, a number of processors may be provided. Furthermore, processes may be implemented with one processor, or processes may be implemented simultaneously or in sequence, or by using different techniques, on one or more processors. Note that the processor 1001 may be implemented with one or more chips.

The functions of the radio base station 10 and the user terminal 20 are implemented by, for example, allowing hardware such as the processor 1001 and the memory 1002 to read given software (programs), and allowing the processor 1001 to do calculations, control communication that involves the communication apparatus 1004, control the reading and/or writing of data in the memory 1002 and the storage 1003, and so on.

The processor 1001 may control the whole computer by, for example, running an operating system. The processor 1001 may be constituted by a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data and so forth from the storage 1003 and/or the communication apparatus 1004, into the memory 1002, and executes various processes according to these. As for the programs, programs to allow computers to execute at least part of the operations of the above-described embodiments may be used. For example, the control section 401 of a user terminal 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus),” and so on. The memory 1002 can store executable programs (program codes), software modules, and so on for implementing the radio communication methods according to the present embodiment.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) or the like), a digital versatile disc, a Blu-ray (registered trademark) disk, etc.), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer and so on, in order to implement, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from outside (for example, a keyboard, a mouse, a microphone, a switch, a button, a sensor and so on). The output apparatus 1006 is an output device for executing output to outside (for example, a display, a speaker, an LED (Light Emitting Diode) lamp, and so on). Note that the input apparatus 1005 and the output apparatus 1006 may be provided in an integrated structure (for example, a touch panel).

Furthermore, these pieces of apparatus, including the processor 1001, the memory 1002 and so on, are connected by the bus 1007, so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by these pieces of hardware. For example, the processor 1001 may be implemented with at least one of these pieces of hardware.

(Variations)

Note that the terminology used in this specification and the terminology that is needed to understand this specification may be replaced by other terms that communicate the same or similar meanings. For example, “channels” and/or “symbols” may be replaced by “signals” (or “signaling”). Also, a signal may be a message. A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency,” and so on.

Furthermore, a radio frame may be comprised of one or more periods (frames) in the time domain. One or more periods (frames) that constitute a radio frame may be each referred to as a “subframe.” Furthermore, a subframe may be comprised of one or more slots in the time domain. A subframe may be a fixed time duration (for example, 1 ms) not dependent on the numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Also, a slot may be a time unit based on numerology. Also, a slot may include a number of minislots. Each minislot may be comprised of one or more symbols in the time domain. Also, a minislot may be referred to as a “subslot.”

A radio frame, a subframe, a slot, a minislot, and a symbol all refer to a unit of time in signal communication. A radio frame, a subframe, a slot, a minislot and a symbol may be each called by other applicable names. For example, one subframe may be referred to as a “transmission time interval (TTI),” or a number of consecutive subframes may be referred to as a “TTI,” or one slot or one minislot may be referred to as a “TTI.” That is, a subframe and/or a TTI may be a subframe (1 ms) in existing LTE, may be a shorter period than 1 ms (for example, one to thirteen symbols), or may be a longer period of time than 1 ms. Note that the unit to represent a TTI may be referred to as a “slot,” a “minislot” and so on, instead of a “subframe.”

Here, a TTI refers to the minimum time unit for scheduling in radio communication, for example. For example, in LTE systems, a radio base station schedules the radio resources (such as the frequency bandwidth and transmission power each user terminal can use) to allocate to each user terminal in TTI units. Note that the definition of TTIs is by no means limited to this.

The TTI may be the transmission time unit of channel-encoded data packets (transport blocks), code blocks and/or codewords, or may be the unit of processing in scheduling, link adaptation and so on. Note that, when a TTI is given, the period of time (for example, the number of symbols) in which transport blocks, code blocks and/or codewords are actually mapped may be shorter than the TTI.

Note that, when one slot or one minislot is referred to as a “TTI,” one or more TTIs (that is, one or more slots or one or more minislots) may be the minimum time unit of scheduling. Also, the number of slots (the number of minislots) to constitute this minimum time unit for scheduling may be controlled.

A TTI having a time length of 1 ms may be referred to as a “general TTI” (TTI in LTE Rel. 8 to 12), a “normal TTI,” a “long TTI,” a “general subframe,” a “normal subframe,” a “long subframe,” and so on. A TTI that is shorter than a general TTI may be referred to as a “shortened TTI,” a “short TTI,” a “partial TTI” (or a “fractional TTI”), a “shortened subframe,” a “short subframe,” a “minislot,” a “sub-slot,” and so on.

Note that a long TTI (for example, a general TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a number of consecutive subcarriers in the frequency domain. Also, an RB may include one or more symbols in the time domain, and may be one slot, one minislot, one subframe or one TTI in length. One TTI and one subframe each may be comprised of one or more resource blocks. Note that one or more RBs may be referred to as a “physical resource block (PRB (Physical RB)),” a “subcarrier group (SCG),” a “resource element group (REG),” a “PRB pair,” an “RB pair,” and so on.

Furthermore, a resource block may be comprised of one or more resource elements (REs). For example, one RE may be a radio resource field of one subcarrier and one symbol.

Note that the structures of radio frames, subframes, slots, minislots, symbols, and so on described above are simply examples. For example, configurations pertaining to the number of subframes included in a radio frame, the number of slots included in a subframe or a radio frame, the number of minislots included in a slot, the number of symbols and RBs included in a slot or a minislot, the number of subcarriers included in an RB, the number of symbols in a TTI, the length of symbols, the length of cyclic prefix (CP), and so on can be variously changed.

Also, the information and parameters described in this specification may be represented in absolute values or in relative values with respect to given values, or may be represented using other applicable information. For example, a radio resource may be indicated by a given index.

The names used for parameters and so on in this specification are in no respect limiting. For example, since various channels (PUCCH (Physical Uplink Control CHannel), PDCCH (Physical Downlink Control CHannel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals, and so on may be input and/or output via a number of network nodes.

The information, signals, and so on that are input and/or output may be stored in a specific location (for example, in a memory), or may be managed in a control table. The information, signals, and so on to be input and/or output can be overwritten, updated, or appended. The information, signals, and so on that are output may be deleted. The information, signals, and so on that are input may be transmitted to other pieces of apparatus.

Reporting of information is by no means limited to the examples/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling, etc.), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as “RRC messages,” and can be, for example, an “RRC connection setup message,” “RRC connection reconfiguration message,” and so on. Also, MAC signaling may be reported using, for example, MAC control elements (MAC CEs (Control Elements)).

Also, reporting of given information (for example, reporting of information to the effect that “X holds”) does not necessarily have to be sent explicitly, and can be sent in an implicit way (for example, by not reporting this piece of information, or by reporting another piece of information).

Decisions may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and so on.

Also, software, instructions, information and so on may be transmitted and received via communication media. For example, when software is transmitted from a website, a server or other remote sources by using wired technologies (coaxial cables, optical fiber cables, twisted-pair cables, digital subscriber lines (DSL) and so on), and/or wireless technologies (infrared radiation, microwaves, and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, three) cells (also referred to as “sectors”). When a base station accommodates a number of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS),” “user terminal,” “user equipment (UE),” and “terminal” may be used interchangeably.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

Furthermore, the radio base stations in this specification may be interpreted as user terminals. For example, the examples/embodiments of the present disclosure may be applied to a configuration in which communication between a radio base station and a user terminal is replaced with communication among a number of user terminals (D2D (Device-to-Device)). In this case, user terminals 20 may have the functions of the radio base stations 10 described above. In addition, terms such as “uplink” and “downlink” may be interpreted as “side.” For example, an “uplink channel” may be interpreted as a “side channel.”

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by their upper nodes. In a network comprised of one or more network nodes with base stations, it is clear that various operations that are performed to communicate with terminals can be performed by base stations, one or more network nodes (for example, MMEs (Mobility Management Entities), S-GWs (Serving-Gateways) and so on may be possible, but these are not limiting) other than base stations, or combinations of these.

The examples/embodiments illustrated in this specification may be used individually or in combinations, which may be switched depending on the mode of implementation. The order of processes, sequences, flowcharts, and so on that have been used to describe the examples/embodiments herein may be re-ordered as long as inconsistencies do not arise. For example, although various methods have been illustrated in this specification with various components of steps in exemplary orders, the specific orders that are illustrated herein are by no means limiting.

The examples/embodiments illustrated in this specification may be applied to systems that use LTE (Long-term evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), other adequate radio communication methods, and/or next-generation systems that are enhanced based on these.

The phrase “based on” as used in this specification does not mean “based only on” unless otherwise specified. In other words, the phrase “based on” means both “based only on” and “based at least on.”

Reference to elements with designations such as “first,” “second,” and so on as used herein does not generally limit the number/quantity or order of these elements. These designations are used herein only for convenience, as a method for distinguishing between two or more elements. It follows that reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database, or some other data structure), ascertaining, and so on. Furthermore, to “judge” and “determine” as used in the present disclosure may be interpreted as meaning making judgements and determinations related to receiving (for example, receiving information), transmitting (for example, transmitting information), inputting, outputting, accessing (for example, accessing data in a memory) and so on. In addition, to “judge” and “determine” as used in the present disclosure may be interpreted as meaning making judgements and determinations related to resolving, selecting, choosing, establishing, comparing, and so on. In other words, to “judge” and “determine” as used in the present disclosure may be interpreted as meaning making judgements and determinations with regard to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be interpreted as “access.”

As used herein, when two elements are connected, these elements may be considered “connected” or “coupled” to each other by using one or more electrical wires, cables, and/or printed electrical connections, and, as a number of non-limiting and non-inclusive examples, by using electromagnetic energy having wavelengths of the radio frequency region, the microwave region and/or the optical region (both visible and invisible).

In the present specification, the phrase “A and B are different” may mean “A and B are different from each other.” The terms such as “leave,” “coupled” and the like may be interpreted likewise.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

(Supplementary Notes)

Now, supplementary notes of the present disclosure will follow below:

<Background>

The timing for transmitting a UL (uplink) channel and/or a UL signal (UL channel/signal) is adjusted based on timing advance (TA). The timing for receiving UL channels/signals from different user terminals (UE (User Terminal)) is adjusted at the radio base station end (also referred to as “TRP (Transmission and Reception Point),” “gNB (gNodeB),” etc.).

Existing LTE (Long Term Evolution) systems (also referred to as, for example, “Rel. 13 (or earlier versions),” “LTE,” “LTE-advanced,” etc.) have no mechanism for controlling timing advances based on beams (or the UL resources) that are applied to UL channels/signals.

<Proposal>

A number of timing advances may be controlled at a user terminal (timing advances may be adjusted based on information about beams (beam information)). To be more specific, timing advances may be adjusted as follows.

A timing advance may be adjusted based on information about a UL beam (UL beam information) and/or information about the resource for a UL reference signal (UL RS resource) (UL RS resource information). For example, the UL beam information may include at least one of a rank indicator (RI), a precoding matrix indicator (PMI) and so forth. The UL RS resource information may include at least one of the indices of resources for a sounding reference signal (SRS) (SRS resource indices (SRIs)).

A timing advance may be adjusted based on information about a DL beam (DL beam information) associated with a UL beam.

A timing advance may be adjusted based on information about quasi-co-location (QCL) (QCL information).

When a number of beams are transmitted at a user terminal, the user terminal may apply the following timing advances to each of the beams.

The user terminal may apply one of a number of timing advances corresponding to a number of beams.

The user terminal may apply a timing advance value derived based on a number of timing advance values (or TA values). For example, a timing advance value which the user terminal uses may be derived by finding the average of a number of timing advance values, or may be the maximum value or the minimum value of a number of timing advance values.

The user terminal may apply individual timing advances on a per beam basis.

When the user terminal switches a beam, the user terminal may control the timing advance value as follows:

The user terminal may maintain the same TA value between different beams.

The user terminal may reset the TA value when changing the beam.

The timing advance control units may be grouped. For example, a group of UL beams (UL beam group) may be formed based on TAs.

In view of the above, the following configurations are proposed. It is obvious that the present disclosure is not limited to the following configurations.

### [Configuration 1]

A user terminal including a transmission section that transmits one or more UL signals based on one or more timing advances, and a control section that controls a timing advance to apply to transmission of a UL signal based on at least one of UL resource information, antenna port information and beam information for the UL signal.

### [Configuration 2]

The user terminal according to configuration 1, in which the control section controls the timing advance to apply to the transmission of the UL signal based on at least one of DL resource information, antenna port information and beam information for a DL signal, related to the at least one of UL resource information, antenna port information and beam information for the UL signal.

### [Configuration 3]

The user terminal according to configuration 1 or configuration 2, in which the control section controls the timing advance to apply to the transmission of the UL signal in units of information related to quasi-co-location.

### [Configuration 4]

The user terminal according to one of configuration 1 to configuration 3, in which, when the transmission section transmits the UL signal using at least one of a plurality of UL resources, a plurality of antenna ports and a plurality of beams, the control section applies the same given timing advance to the plurality of UL resources, the plurality of antenna ports and the plurality of beams.

### [Configuration 5]

The user terminal according to configuration 4, in which the control section determines the given timing advance based on a plurality of timing advances.

### [Configuration 6]

The user terminal according to one of configuration 1 to configuration 3, in which, when the transmission section transmits the UL signal using at least one of a plurality of UL resources, a plurality of antenna ports and a plurality of beams, the control section applies individual timing advances to the at least one of the plurality of UL resources, the plurality of antenna ports and the plurality of beams, respectively.

### [Configuration 7]

The user terminal according to one of configurations 1 to 6, in which, when the control section changes at least one of the UL resource information, antenna ports and beams to use to transmit the UL signal, the control section applies the same timing advance as before the change to at least one of the UL resource information, the antenna ports and the beams after the change.

### [Configuration 8]

The user terminal according to one of configurations 1 to 6, in which, when the control section changes at least one of the UL resource information, antenna ports and beams to use to transmit the UL signal, the control section resets the timing advance.

### [Configuration 9]

The user terminal according to one of configurations 1 to 8, in which the control section groups control units for timing advance.

### [Configuration 10]

A radio communication method including, in a user terminal, the steps of transmitting one or more UL signals based on one or more timing advances, and

controlling a timing advance to apply to transmission of a UL signal based on at least one of UL resource information, antenna port information and beam information for the UL signal.

Now, although the present disclosure has been described in detail above, it should be obvious to a person skilled in the art that the invention concerning the present disclosure is by no means limited to the embodiments described herein. The invention concerning the present disclosure can be implemented with various corrections and in various modifications, without departing from the spirit and scope of the present invention defined based on the recitations of claims. Consequently, the description herein is provided only for the purpose of explaining examples, and should by no means be construed to limit the invention concerning the present disclosure in any way.

This application is based on Japanese Patent Application No. 2018-048578, filed on Feb. 27, 2018, including the specification, drawings and abstract, is incorporated herein by reference in its entirety.

1. A user terminal comprising:
a transmission section that transmits one or more UL signals based on one or more timing advances; and
a control section that controls a timing advance to apply to transmission of a UL signal based on at least one of UL resource information, antenna port information and beam information for the UL signal.

2. The user terminal according to claim 1, wherein the control section controls the timing advance to apply to the transmission of the UL signal based on at least one of DL resource information, antenna port information and beam information for a DL signal, related to the at least one of UL resource information, antenna port information and beam information for the UL signal.

3. The user terminal according to claim 1, wherein the control section controls the timing advance to apply to the transmission of the UL signal in units of information related to quasi-co-location.

4. The user terminal according to claim 1, wherein, when the transmission section transmits the UL signal using at least one of a plurality of UL resources, a plurality of antenna ports and a plurality of beams, the control section applies a same given timing advance to the plurality of UL resources, the plurality of antenna ports and the plurality of beams.

5. The user terminal according to claim 4, wherein the control section determines the given timing advance based on a plurality of timing advances.

6. A radio communication method comprising, in a user terminal, the steps of:
transmitting one or more UL signals based on one or more timing advances; and
controlling a timing advance to apply to transmission of a UL signal based on at least one of UL resource information, antenna port information and beam information for the UL signal.

7. The user terminal according to claim 2, wherein the control section controls the timing advance to apply to the transmission of the UL signal in units of information related to quasi-co-location.

8. The user terminal according to claim 2, wherein, when the transmission section transmits the UL signal using at least one of a plurality of UL resources, a plurality of antenna ports and a plurality of beams, the control section applies a same given timing advance to the plurality of UL resources, the plurality of antenna ports and the plurality of beams.

9. The user terminal according to claim 3, wherein, when the transmission section transmits the UL signal using at least one of a plurality of UL resources, a plurality of antenna ports and a plurality of beams, the control section applies a same given timing advance to the plurality of UL resources, the plurality of antenna ports and the plurality of beams.
